(19) United States
(12) Patent Application Publication
(10) Pub. No.: US 2026/0370315 A1
(43) Pub. Date: Nov. 19, 2026

(54) SYSTEM AND METHOD FOR DETERMINING NON-TERRESTRIAL NETWORK AVAILABILITY

(71) Applicant: T-MOBILE INNOVATIONS LLC, Overland Park, KS (US)

(72) Inventors: Sharath SOMASHEKAR, Overland Park, KS (US); Jennifer Feria REYES, Bothell, WA (US); Jacob Andrew FONTANA, Kirkland, WA (US); Rashmi KUMAR, Herndon, VA (US); Manoj Kumar GUPTA, Sammamish, WA (US)

(21) Appl. No.: 19/209,023

(22) Filed: May 15, 2025

(51) Int. Cl. H04B 7/185

(52) U.S. Cl. CPC H04B 7/18517

(57) ABSTRACT

At a high level, the technology disclosed herein relates to enhancing communication services based on determining non-terrestrial network availability and usability. In embodiments, a system includes a computing device that continuously sends itself a signal over a non-terrestrial network, a pair of computing devices where an origin device transmits a signal over the non-terrestrial network to a terminator device that receives the signal over a terrestrial network, a pair of computing devices where an origin device transmits a signal over the terrestrial network to a terminator device that receives the signal over the non-terrestrial network, and a computing device that attaches and detaches to the non-terrestrial network. The non-terrestrial network availability and usability are determined using the non-terrestrial network data generated by this system. Various communication services are enhanced using the determined non-terrestrial network availability and usability.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for determining non-terrestrial network metrics, such as non-terrestrial network availability and usability. The non-terrestrial network metrics can be used to trigger an adjustment associated with the non-terrestrial network. For example, the adjustment may be associated with one or more network nodes of the non-terrestrial network. Additionally, a system for determining non-terrestrial network metrics is provided.

In embodiments, the system for determining non-terrestrial network metrics, such as non-terrestrial network availability and usability, may include one or more of a computing device continuously sending itself a signal over the non-terrestrial network, a pair of computing devices including an origin device that transmits a signal to a terminator device, a computing device that attaches and detaches to the non-terrestrial network, and another pair of computing devices including an origin device and terminator device, wherein the origin device transmits a signal over the terrestrial network to the terminator device that receives the signal over the non-terrestrial network. In some embodiments, one or more of the signals being transmitted by the computing devices of this system may be a short messaging service, a rich communication service, a multimedia service, another type of signal, etc.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for determining non-terrestrial availability and usability, in accordance with embodiments herein;

FIG. 2 depicts another example environment for determining non-terrestrial availability and usability, in accordance with embodiments herein;

FIG. 3 illustrates an example for determining non-terrestrial usability, in accordance with embodiments herein;

FIGS. 4-7 illustrate examples of non-terrestrial network data generated using the example operating environment of FIG. 1, in accordance with embodiments herein;

FIG. 8 depicts an example flowchart of the functionality associated with the present technology, in accordance with embodiments herein;

FIG. 9 depicts example non-terrestrial network node functionality corresponding to the present technology, in accordance with embodiments herein; and

FIG. 10 depicts an example computing device and example computing device functionality for implementation of the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

As used herein, the term “direct-to-cell” corresponds to providing a communication service (e.g., text messaging, voice communication coverage, data coverage, network access technology associated with a communication protocol and user device, such as 3G, 4G, 5G, 6G, another generation technology, 802.11x, etc., or one or more combinations thereof) directly to a user device via a satellite without a terrestrial base station.

The term “non-terrestrial node” is distinguished from a terrestrial network access node, such as a terrestrial base station, on the basis of its lack of ground coupling. Some examples of a non-terrestrial node may include a very low earth orbit satellite, a low earth orbit satellite, a medium earth orbit satellite, a regenerative satellite, a space satellite, a balloon, a dirigible, an airplane, a drone (e.g., an unmanned aerial vehicle), a geosynchronous or geostationary earth orbit satellite, another type of satellite, another type of non-terrestrial node, etc., or one or more combinations thereof.

The term “terminator device” refers to the recipient of a signal transmitted by an “origin device.” In some embodiments, a terminator device may refer to a computing device that is configured to receive a particular signal, or a computing device that is configured to only receive signals from a particular computing device.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, there have been attempts at generating or developing 3rd Generation Partnership Project (3GPP) methods to assess end user performance of a satellite network similar to the 3GPP methods for terrestrial networks. Problems associated with these attempts include the satellites not having a fixed location (e.g., such as for an eNB/gNB terrestrial base station). In addition, the manner in which user equipment (UE) testing devices will camp onto a node is solely based on projections of the satellite trajectory, which yield a flyover schedule allowing users to simply guess at the approximate time that a satellite may be overhead. Stated differently, these testing UEs would have to wait for an eNB/gNB attached to a satellite at a particular location and time to test or measure the end user performance of the satellite network. Further, the duration of the satellite flyby is another challenge (e.g., for Low Earth Orbit satellites (LEOs) traversing an orbit around 17,000 mph). By way of illustration, a LEO beam may serve a UE between one to ten seconds for a vast number of instances, and between ten to sixty seconds for a lower number of instances, the amount of seconds serving the UE being based on the azimuth of the UE’s position to the satellite (e.g., typically 32 degrees to 81 degrees). Accordingly, a testing UE would barely have any time to (a) detect, (b) setup the test, and (c) run an actual test. Furthermore, satellite networks may be owned by different operators, meaning that the testing UEs will likely roam on a plethora of such satellite-based solutions, resulting in no visibility from the network side or to any changes made by a different operator to fine tune their network.

The present technology improves upon these technological problems in various ways. For example, the methods, systems, media, techniques, etc., provided include improvements on both how and when to measure and assess the non-terrestrial network for making enhancements to communications services associated with the non-terrestrial network, improvements to visibility from the network side or to any changes that different operators have made, etc. For example, the presently disclosed technology provides a particular system for determining non-terrestrial network metrics including non-terrestrial network availability and usability, which are used for triggering one or more adjustments (e.g., to a communication service provided by the non-terrestrial network, to a transmission by the non-terrestrial node, toggling communication services based on the non-terrestrial network metrics).

In an embodiment, a method comprises determining a non-terrestrial network metric of a non-terrestrial network from non-terrestrial network data obtained from: a computing device continuously sending itself a signal over the non-terrestrial network, a pair of computing devices including an origin device and terminator device, wherein the origin device transmits a signal over the non-terrestrial network to the terminator device that receives the signal from the origin device over a terrestrial network, a computing device that attaches and detaches to the non-terrestrial network, and a pair of computing devices including an origin device and terminator device, wherein the origin device transmits a signal over the terrestrial network to the terminator device that receives the signal over the non-terrestrial network. The method may also comprise triggering an adjustment, associated with the non-terrestrial network, based on the non-terrestrial network metric determined.

In another embodiment, one or more computer storage media having computer-executable instructions are provided. When executed by at least one processor, the media cause the at least one processor to perform a method. The method may comprise determining a non-terrestrial network metric of a non-terrestrial network from non-terrestrial network data obtained from: a computing device continuously sending itself a signal over the non-terrestrial network, a pair of computing devices including an origin device that transmits a signal to a terminator device, and a computing device that attaches and detaches to the non-terrestrial network. The method may also comprise triggering an adjustment, associated with the non-terrestrial network, based on the non-terrestrial network metric determined.

In another example embodiment, a system for determining non-terrestrial network metrics, such as non-terrestrial network availability and usability, is provided. The system comprises a first computing device configured to continuously send itself a signal over a non-terrestrial network. The system also comprises a second computing device configured to transmit a signal over the non-terrestrial network to a third computing device, the third computing device configured to receive the signal from the second computing device from a terrestrial network. The system also comprises a fourth computing device configured to transmit a signal over the terrestrial network to a fifth computing device, the fifth computing device configured to receive the signal from the fourth computing device from the non-terrestrial network. In some embodiments, the first computing device has a subscriber identification module (SIM), wherein a system on chip (SoC) of the SIM is provisioned to avoid terrestrial attachment for the first computing device to be configured to send itself the signal over the non-terrestrial network. In some embodiments, the system further comprises another computing device configured to attach and detach to the non-terrestrial network. In embodiments, the system comprises a database that receives non-terrestrial network data from the first computing device, the second computing device, the third computing device, the fourth computing device, the fifth computing device, and the other computing device that attaches to and detaches from the non-terrestrial network.

### Example Operating Environments

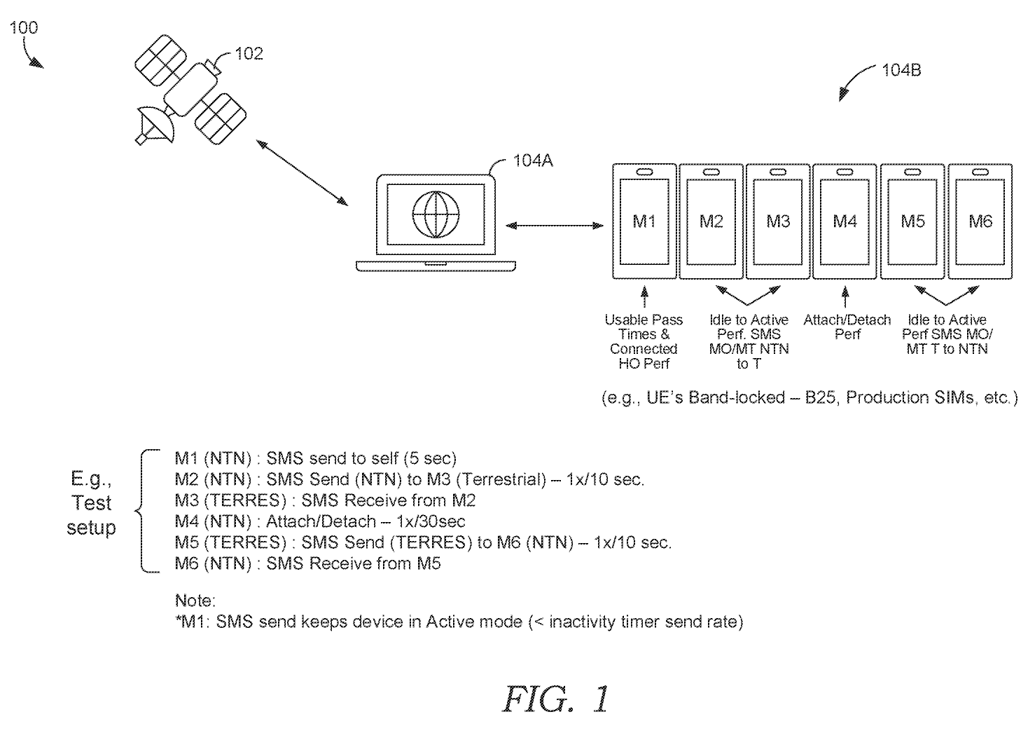

Turning now to FIG. 1, example operating environment 100 is illustrated in accordance with one or more embodiments disclosed herein. At a high level, the example operating environment 100 comprises non-terrestrial node 102 and non-terrestrial network analysis system 104A and 104B. Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional or different types of computing device and non-terrestrial nodes of the non-terrestrial network testing and analysis system 104A and 104B.

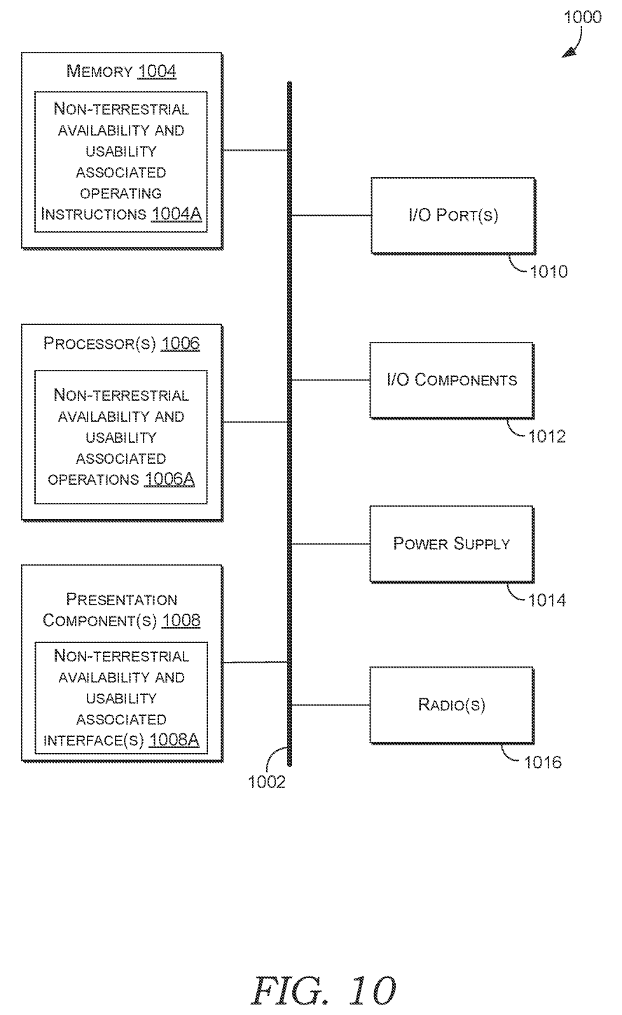

The non-terrestrial network analysis system 104A may include a computing device, and the system 104B may include a plurality of computing devices including M1, M2, M3, M4, M5, and M6. A computing device may be a device that has the capability of transmitting or receiving one or more signals (e.g., over the non-terrestrial network, over the terrestrial network). In some embodiments, a “computing device” may be referred to as a “user device,” “mobile device,” “user equipment (UE),” “wireless communication device,” a “server,” etc. A computing device, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating with a satellite. A user device may be, in an embodiment, computing device 1000 described herein with respect to FIG. 10.

The non-terrestrial node 102 may be configured as a non-terrestrial network (e.g., a 3GPP non-terrestrial network) or part of a non-terrestrial network. For example, the non-terrestrial network may be connecting one or more gateways (e.g., a ground station comprising one or more devices or a system of components configured to provide an interface between a terrestrial network and the non-terrestrial network) to other network(s). In some embodiments, one or more particular non-terrestrial node beams may be provided by the non-terrestrial node 102 over a given terrestrial geographical area. In embodiments, the non-terrestrial node 102 may transmit signals transmitted by one or more of the computing devices M1, M2, M3, M4, M5, and M6 over the non-terrestrial network. In embodiments, the non-terrestrial node 102 may provide the non-terrestrial network via direct-to-cell and may also communicates with a ground station.

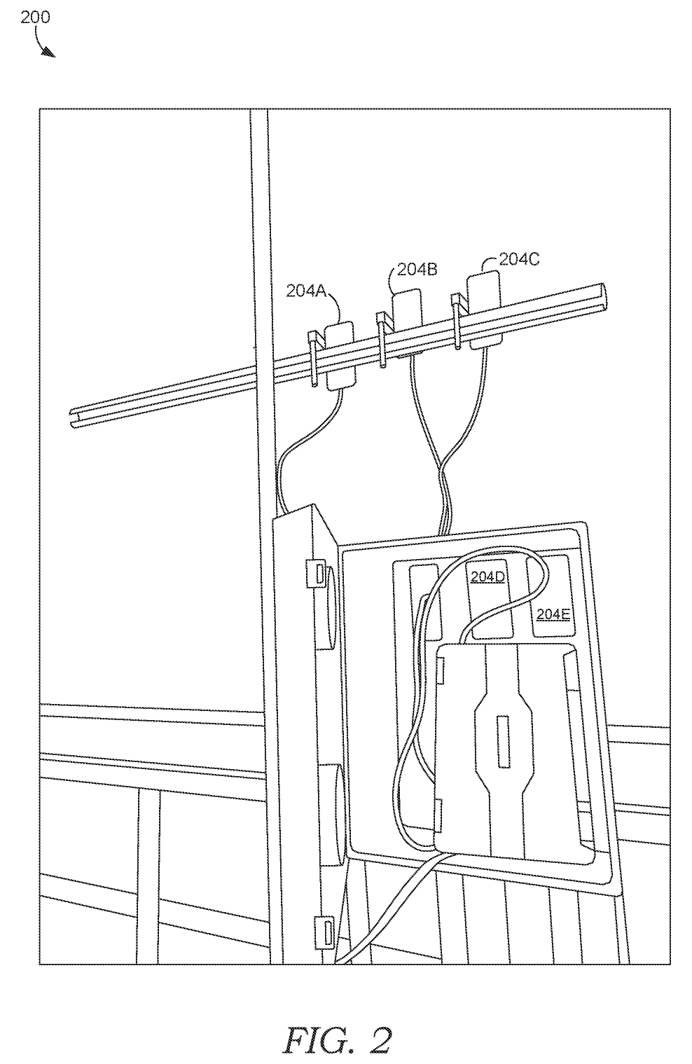

In embodiments, a computing device (e.g., each of M1, M2, M3, M4, M5, and M6) may be stationed on a rooftop, in a remote area, etc. In embodiments, the rooftop positioning associated with some of the computing devices of the non-terrestrial network analysis system 104A and 104B may include an arrangement of computing device 204A-204E illustrated in environment 200 of FIG. 2 . For example, at least some of the plurality of computing devices (e.g., one or more of M1, M2, M3, M4, M5, and M6) may be positioned for a better line of sight with the non-terrestrial node 102 than other computing devices of the non-terrestrial network analysis system 104A and 104B. To illustrate, the computing devices 204A, 204B, and 204C may be positioned for a better line of sight with the non-terrestrial node 102 than the computing devices 204D and 204E.

In embodiments, one or more of the non-terrestrial network analysis system 104A and 104B (including M1, M2, M3, M4, M5, and M6) may be utilized for determining a non-terrestrial network metric (e.g., non-terrestrial network availability, non-terrestrial network usability). For example, the non-terrestrial network analysis system 104A and 104B (including M1, M2, M3, M4, M5, and M6) may be utilized to obtain non-terrestrial network data. In embodiments, one or more of the non-terrestrial network availability and usability may be used to enhanced one or more communication services (e.g., Internet browsing, Wi-Fi, Voice over IP, gaming, High Frequency Trading, SMS, MMS, an emergency medical service, another type of communication service, or one or more combinations thereof) associated with the non-terrestrial network.

In embodiments, M1 is a computing device continuously sending itself a signal over the non-terrestrial network. In embodiments, M2 and M3 are a pair of computing devices including an origin device M2 and terminator device M3, wherein the origin device M2 transmits a signal over the non-terrestrial network to the terminator device M3 that receives the signal from the origin device M2 over a terrestrial network. In embodiments, M4 is a computing device that attaches and detaches to the non-terrestrial network. In embodiments, M5 and M6 are a pair of computing devices including an origin device M5 and terminator device M6, wherein the origin device M5 transmits a signal over the terrestrial network to the terminator device M6 that receives the signal over the non-terrestrial network. In embodiments wherein some computing devices of the non-terrestrial network analysis system are positioned for a better line of sight with the non-terrestrial node 102 than other computing devices of this system, the computing devices 204A-204C of FIG. 2 may include M1, M2, and M4. In other implementations of this embodiment, the computing devices having the better line of sight may include M1, M2, M4, and M6.

In some embodiments, M1 is a computing device that is continuously sending itself a signal (e.g., a Short Message Service (SMS), a Rich Communication Service (RCS), another type of messaging service, a video service, an audio service, a multimedia service, etc.) over the non-terrestrial network (e.g., every five seconds). In embodiments, the computing device M1, which is continuously sending itself the signal, is continuously pinging a particular server to maintain connection with the non-terrestrial network to avoid connecting with the terrestrial network. In embodiments, M1 continuously remains in this connected state with the non-terrestrial network, without redirecting to the terrestrial network. In some embodiments, M1 may be locked onto the non-terrestrial network by one or more Public Land Mobile Network (PLMN) band locking techniques (e.g., causing M1 to connect only with a specific frequency band, such as band 25, that the non-terrestrial network uses for transmitting and receiving signals). In some embodiments, M1 may be locked onto the non-terrestrial network by another type of locking mechanism (e.g., Open Radio Access Network locking mechanism) or non-terrestrial network element locking mechanism that causes M1 to maintain connection with the non-terrestrial network instead of connecting with the terrestrial network. In some embodiments, M1 may have a subscriber identification module (SIM), a system on chip (SoC) of the SIM being provisioned to avoid terrestrial attachment for M1 to be configured to send itself the signal over the non-terrestrial network. The SIM provisioning (e.g., an eSIM or physical SIM) may be provisioned to cause M1 to maintain connection with the non-terrestrial network instead of connecting with the terrestrial network. As M1 is configured to continuously send itself a signal over the non-terrestrial network, M1 may initiate transmission of these signals (e.g., the same signals or different signals, such as M1 continuously sending itself the same SMS, or continuously sending itself text, image, text, image, etc.) to itself over the non-terrestrial network.

In embodiments, one or more of the non-terrestrial network metrics are determined based on keeping M1 in connected mode with the non-terrestrial network and measuring the connected mode handovers, performance of the signals that M1 is transmitting to itself, the roundtrip time latency of the M1 pinging the particular server, roundtrip time success rate of the signal that M1 is sending itself, or one or more combinations thereof. For example, non-terrestrial network availability can be determined based on keeping M1 in connected mode and measuring the connected mode handovers, performance of the signals that M1 is transmitting to itself, the roundtrip time latency of the M1 pinging the particular server, roundtrip time success rate of the signal that M1 is sending itself, or one or more combinations thereof.

“Non-terrestrial network availability” refers to a time or duration that the non-terrestrial node beam will be detectable by a computing device. By way of illustration, conventional methods and systems generally try to identify when a satellite will be overhead. However, mere overhead (e.g., for 80% chance of non-terrestrial node beam coverage) does not mean that a computing device can interact or detect this beam with a flawless readable signal. For instance, a UE may in fact only detect the non-terrestrial node beam for 47%, and of that 47% only 33% may be usable. As such, “non-terrestrial network availability” refers to the capability of the UE detecting the non-terrestrial node beam (e.g., during a satellite flyby), and “non-terrestrial network usability” refers to the capability of the UE to utilize the non-terrestrial node beam (e.g., for a particular communication service that requires particular network capabilities).

In embodiments, the non-terrestrial network availability may be determined based on filtering non-terrestrial network data (e.g., obtained using M1 locked onto the non-terrestrial network to continuously transmit messages to itself) by PLMN to identify the non-terrestrial network data. The non-terrestrial network availability may be determined based on the delta or the difference between a start timestamp and end timestamp of a particular physical cell identity (PCI), eNB/gNB, cell identity, etc., or one or more combinations thereof, to identify various granularities of time served at the per-beam level, per-satellite level. Stated differently, the non-terrestrial network availability may be determined based on a duration that a particular non-terrestrial node beam of a particular non-terrestrial node served the computing device (e.g., M1 continuously sending itself the signal). Additionally or alternatively, the non-terrestrial network availability may be determined based on a second duration that a second particular non-terrestrial node beam of the particular non-terrestrial node served M1. Additionally or alternatively, the non-terrestrial network availability may be determined based on a third duration that a third particular non-terrestrial node beam of a second particular non-terrestrial node served M1. In some embodiments, the duration is identified or determined by measuring an LTE M1 serving cell result message (e.g., for a chipset, for a particular PCI, eNB, timing identifier, etc.). In some embodiments, the non-terrestrial network data includes usable past time, a connected mode handover, a performance of the signal being transmitted by M1 to itself, other types of non-terrestrial network data, or one or more combinations thereof, for determining non-terrestrial network availability.

In some embodiments, the non-terrestrial network availability (e.g., a non-terrestrial network metric) may be determined by identifying a duration that a particular non-terrestrial node beam of a particular non-terrestrial node (e.g., non-terrestrial node 102) served one or more of the computing device continuously sending itself the signal (e.g., M1), an origin device transmitting a signal over the non-terrestrial network (e.g., M2) to the terminator device (e.g., M3) that receives this signal over a terrestrial network, the computing device attaching and detaching to the non-terrestrial network (e.g., M4), and the terminator device that receives a signal over the non-terrestrial network (e.g., M6) from an origin device that sent this signal over a terrestrial network (e.g., M5).

In some embodiments, non-terrestrial network availability thresholds may be determined. For example, non-terrestrial network availability thresholds may be used for triggering a power change to the non-terrestrial node 102 (or another non-terrestrial node) to save power on one beam, such that the saved power may be utilized to transmit another beam. For example, these thresholds may be based on an elevation, a baseline number of subscribers within a particular coverage area, a particular service level agreement or portion thereof, etc., or one or more combinations thereof. For instance, when the non-terrestrial network availability is above the threshold, an adjustment to provide a data service to a set of computing devices can be triggered based on the non-terrestrial network usability being above the threshold. The adjustment to provide the data service to the set of computing devices may include triggering a power change to the non-terrestrial node 102, triggering or providing an alarm or notification (e.g., to an interface of a computing device of a particular non-terrestrial network provider) that a particular non-terrestrial node or non-terrestrial node beam is not meeting a service level agreement or portion thereof, enabling or disabling a particular communication service (e.g., enabling a particular messaging service and disabling a different service that requires a particular latency measurement) based on the non-terrestrial network availability, etc., or one or more combinations thereof. In some embodiments, the non-terrestrial network availability may be fed from a user device perspective over a 3GPP protocol in an uplink message back to the non-terrestrial node 102 (e.g., the messaging indicating that a particular user device received a particular amount of coverage for a particular time period or duration and an indication for enhanced service).

In embodiments, M2 (e.g., origin device of the M2 and M3 pair) may transmit a particular SMS, RCS, multimedia service (MMS), a picture message, a signal transmission with voice data, video call, etc. over the non-terrestrial network. In embodiments, M2 and M3 are connected to the same setup so that the logs associated with the M2 signal transmission and M3 signal reception are captured using the same ecosystem for determining end to end times. For example, modem logs in the network, signaling messages, computing device state, etc., may be used for generating non-terrestrial network data. In a similar manner, M5 (e.g., origin device of the M5 and M6 pair) may transmit a particular SMS, RCS, multimedia service (MMS), a picture message, a signal transmission with voice data, video call, etc., over the terrestrial network. In embodiments, M5 and M6 are connected to the same setup so that the logs associated with the M5 signal transmission over the terrestrial network and M6 signal reception over the non-terrestrial network are captured using the same ecosystem for determining end to end times. For example, modem logs in the network, signaling messages, computing device state, etc., may be used for generating non-terrestrial network data. With M4 transitioning between active and idle state (e.g., an airplane mode toggle) with the non-terrestrial network, the non-terrestrial network data (e.g., transition times between active and idle, transition time success, attachment success, etc.) for these two states may be obtained. The non-terrestrial network data obtained may be used for determining non-terrestrial network metrics (e.g., non-terrestrial network usability). The non-terrestrial network usability may refer to the capability of the UE to utilize the non-terrestrial node beam (e.g., for a particular communication service that requires particular network capabilities).

For example, while a satellite may be overhead, this does not always mean that the signal quality is adequate to be used by user devices within a coverage area. To determine non-terrestrial network usability using the M1-M6 computing devices, in some embodiments, a Metric Start Trigger may be determined using: Initial Attach Complete [Initial Attach] Sent by a UE or RRCConnectionSetupComplete [This is during Idle to Connect] (if UE context known). Additionally, to determine non-terrestrial network usability, Metric End Trigger may be determined using: signal fade at end of pass below Qrxlevmin or PCI Shift [RRC Reconfiguration Complete].

Stated differently, non-terrestrial network usability may be determined based on a connection trigger (e.g., the Metric Start Trigger) with the non-terrestrial network for one or more of the computing device continuously sending itself the signal (M1), the origin device transmitting the signal over the non-terrestrial network (M2), the computing device attaching and detaching to the non-terrestrial network (M4), the terminator device that receives the signal over the non-terrestrial network (M6), a connection trigger for each of M1-M6, etc., or one or more combinations thereof. Additionally, non-terrestrial network usability may be determined based on a signal fade, measured after the connection trigger and the signal fade being associated with the connection trigger, the signal fade being below a threshold (e.g., Qrxlevmin or PCI Shift) for one or more of M1-M6.

Additionally or alternatively, the non-terrestrial network usability, being the non-terrestrial network metric, may be determined based on the non-terrestrial network that corresponds to radio resource control, enhanced service provider management, and enterprise mobility management. For example, the non-terrestrial network usability for the non-terrestrial network associated with M1-M6 may be determined using state logic for each of the M1-M6 computing devices that is associated with one or more of Radio Resource Control (RRC), Enhanced Service Provider Management (ESPM), Enterprise Mobility Management (EMM), etc., or one or more combinations thereof. The RRC, ESPM, and EMM state logic may correspond to an idle state, a transition between active and idle state, an active state, connection reconfiguration, provisioning and subscription management, service activation state, service handover, authentication and registration states, etc.

In embodiments, one or more of the non-terrestrial network metrics are determined based on M4 transitioning between active and idle state (e.g., an airplane mode toggle) with the non-terrestrial network and measuring the connected mode handovers, performance of control channel signals that M4 is transmitting or receiving, the roundtrip time latency of the control signals between the non-terrestrial node (e.g., non-terrestrial node 102), roundtrip time success rate of the control channel signals, etc., or one or more combinations thereof. The non-terrestrial network data including the connected mode handovers, performance of control channel signals that M4 is transmitting or receiving, the roundtrip time latency of the control signals between the non-terrestrial node (e.g., non-terrestrial node 102), roundtrip time success rate of the control channel signals, etc., or one or more combinations thereof, may be used to determine the non-terrestrial network usability.

In some embodiments, determining non-terrestrial network usability (e.g., a non-terrestrial network metric) may include using the following for one or more of the devices from which the non-terrestrial network data was obtained (e.g., M1-M6): RACH RESULT = SUCCESS (AND) RRC STATE = CONNECTED (AND) EMM State = EMM_REGISTERED (AND) EMM Sub-state = EMM _REGISTERED_NORMAL SERVICE (+) RACH RESULT = SUCCESS (AND) RRC STATE = IDLE_CONNECTED (AND) EMM State = EMM_REGISTERED (AND) EMM Sub-state = EMM _REGISTERED_NORMAL SERVICE. For example, using this method for determining the usability, particular State logic may be captured, which indicates whether a UE is absolutely connected to a non-terrestrial network and is able and ready to receive services from a particular non-terrestrial beam, a particular non-terrestrial operator, a particular non-terrestrial terrestrial node, etc., or one or more combinations thereof.

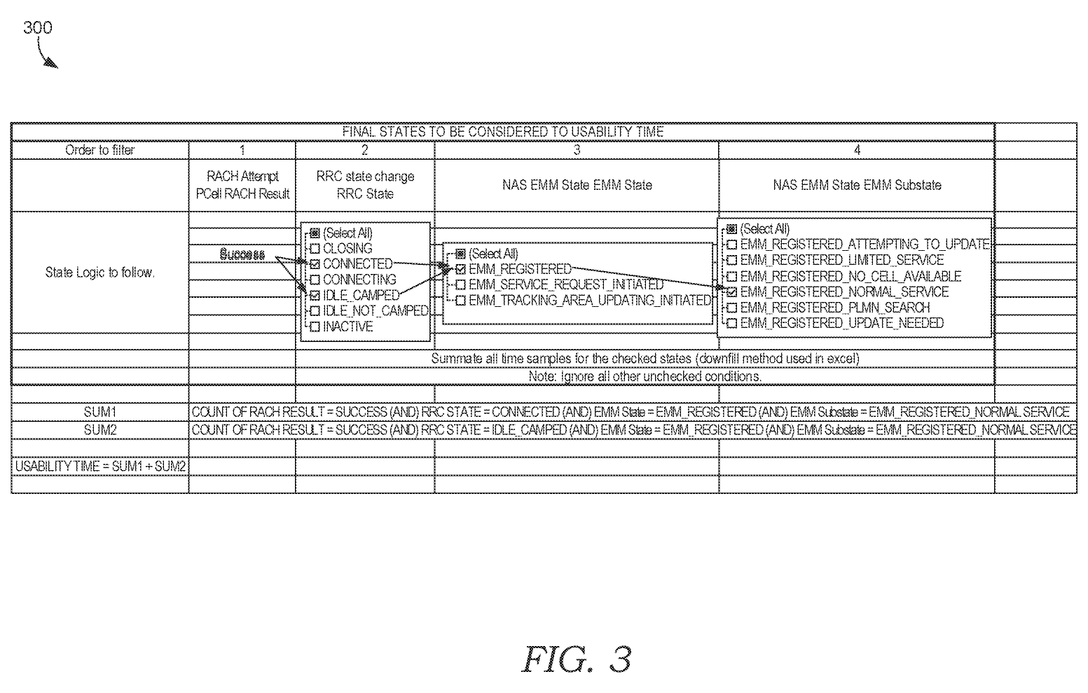

For example, by causing M1 to ping a particular server continuously (e.g., for 24 hours a day), the server is capable of using the measured time that a ping was received as an indication of the usability time for data services via the non-terrestrial network. To illustrate, by measuring the RACH states to determine whether a particular UE is trying to connect with a non-terrestrial node and whether the RACH is successful, counting the number of seconds that the UE has a successful RACH, and determining durations associated with the UE being in RRC connected and idle, the non-terrestrial network usability may be determined, as illustrated in table 300 of FIG. 3. The arrows illustrated in table 300 of FIG. 3: one path is the sum of times (i.e., sum one), a second path is the sum of these times (i.e., sum two), and non-terrestrial network usability may be the sum of these two paths. In embodiments, non-terrestrial network usability is the number of seconds when the UE is in either of these paths.

In embodiments, with respect to M2 and M3, non-terrestrial network data associated with how many messages are being sent from M2 to M3 may be measured (e.g., within a three minute time frame, within a one minute time frame, within a thirty seconds time frame, etc.). By measuring the end-to-end messaging, messaging delay time, the number of messages delivered within a particular number of seconds (or another time metric), etc., may be used for determining the non-terrestrial network usability. In embodiments, the number of messages delivered within a particular time frame may correspond to particular service level agreements. In some embodiments, the particular service level agreements or other non-terrestrial network metrics determined using M1-M6 may be used for determining non-terrestrial network usability thresholds.

For example, a non-terrestrial network usability threshold (e.g., and the availability threshold) may be used for triggering a power change to the non-terrestrial node 102 (or another non-terrestrial node) to save power on one beam, such that the saved power may be utilized to transmit another beam. For example, these usability thresholds may be based on an elevation, a baseline number of subscribers within a particular coverage area, a particular service level agreement or portion thereof, etc., or one or more combinations thereof. For instance, whether the non-terrestrial network usability satisfies a threshold or not, an adjustment to provide a data service to a set of computing devices can be triggered. The adjustment to provide the data service to the set of computing devices may include triggering a power change to the non-terrestrial node 102, triggering or providing a notification (e.g., to an interface of a computing device of a particular non-terrestrial network provider), enabling or disabling a particular communication service, etc., or one or more combinations thereof. In some embodiments, the non-terrestrial network usability may be fed from a user device perspective over a 3GPP protocol in an uplink message back to the non-terrestrial node 102 (e.g., the messaging indicating that a particular user device received a particular amount of coverage for a particular time period or duration and an indication for enhanced service).

In embodiments, the non-terrestrial network usability threshold may be determined based on a number of breaks (e.g., the lower the number of breaks, the better continuity of the service). When the usability threshold is below a certain break number, the user devices within a particular coverage area may be provided with an enhanced communication service (e.g., Internet service and data service). In embodiments, triggering the adjustment based on the non-terrestrial network usability may include deploying or disabling data services based on the number of breaks, causing the user device feature functionality (associated with the enabling and disabling of the data services) to toggle between particular data services, etc. Through these methods, the non-terrestrial network, including the portions operated by different operators, can be monitored and the adjustments can be triggered even though portions of the non-terrestrial network may correspond to different operators.

In embodiments, applications used to send and receive the SMS, MMS, RCS etc., (e.g., associated with M1-M6) may be any native applications on the computing device, or maybe a custom built .apk allowing for continuous send and receive messaging, with option to toggle/lock to each type of service (e.g., with the non-terrestrial network). To determine SMS Mobile Originated (MO) to Mobile Terminated (MT) success rate (e.g., associated with the M2-M3 and M5-M6 pairs), when using Non-Access Stratum (NAS), MO start message : SMS SUBMIT message containing Up-Link (UL) NAS Control Plane (CP) data message bearing the content of the SMS being sent; MO end message: 2nd SMS Deliver report containing the UL NAS CP acknowledgement (ACK) corresponding to the transaction ID used during send; MT start message SMS SUBMIT message containing DL NAS CP data message bearing the content of the SMS being sent; MT end message: 2nd SMS Deliver report containing the DL NAS CP ACK corresponding to the transaction ID used during send. To determine SMS Mobile Originated (MO) to Mobile Terminated (MT) success rate (e.g., associated with the M2-M3 and M5-M6 pairs), when using IP Multimedia Subsystem (IMS), MO DEVICE: Session Initiation Protocol (SIP) transmission message containing the particular Cseq and CallID as well as SIP/2,0 200 OK message; MT DEVICE : SIP Rx Message containing the particular Cseq and CallID as well as SIP/2,0 202 accepted message.

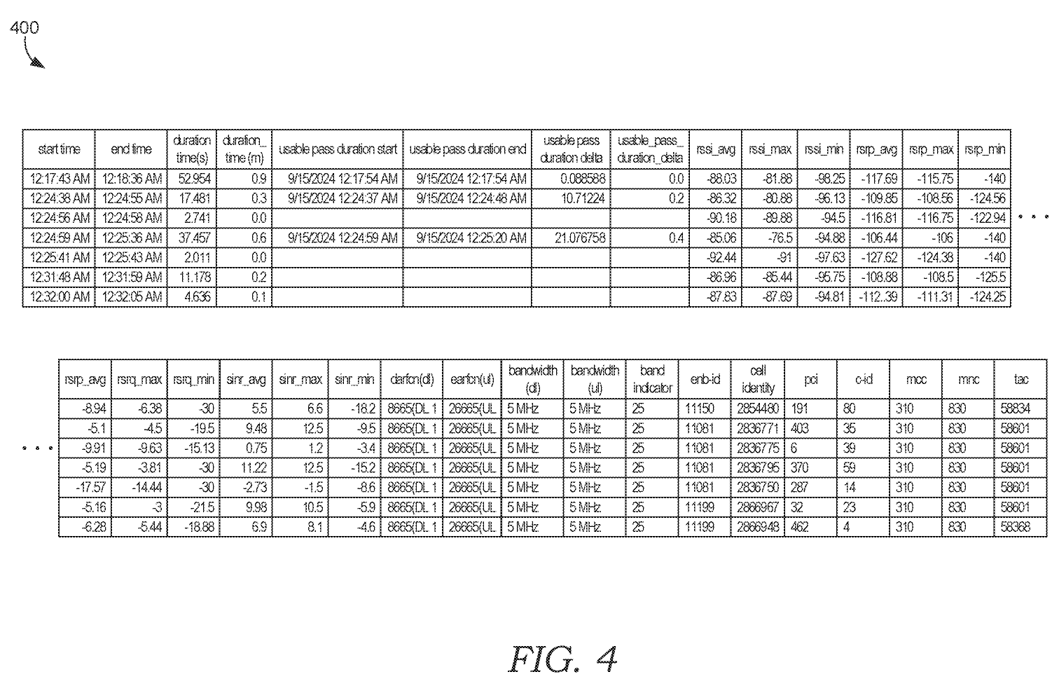

Table 400 of FIG. 4 illustrates the continuous analysis of non-terrestrial network metrics for triggering the adjustment, associated with the non-terrestrial network, associated with the non-terrestrial network availability and the non-terrestrial network usability. For example, the non-terrestrial network availability and the non-terrestrial network usability may be determined based on the following non-terrestrial network data associated with M1-M6: start time, end time, duration time, usable pass duration start and end, usable pass duration delta, Received Signal Strength Indicator (RSSI) measurements (e.g., associated with M3 and M6), non-terrestrial network node bandwidth, etc.

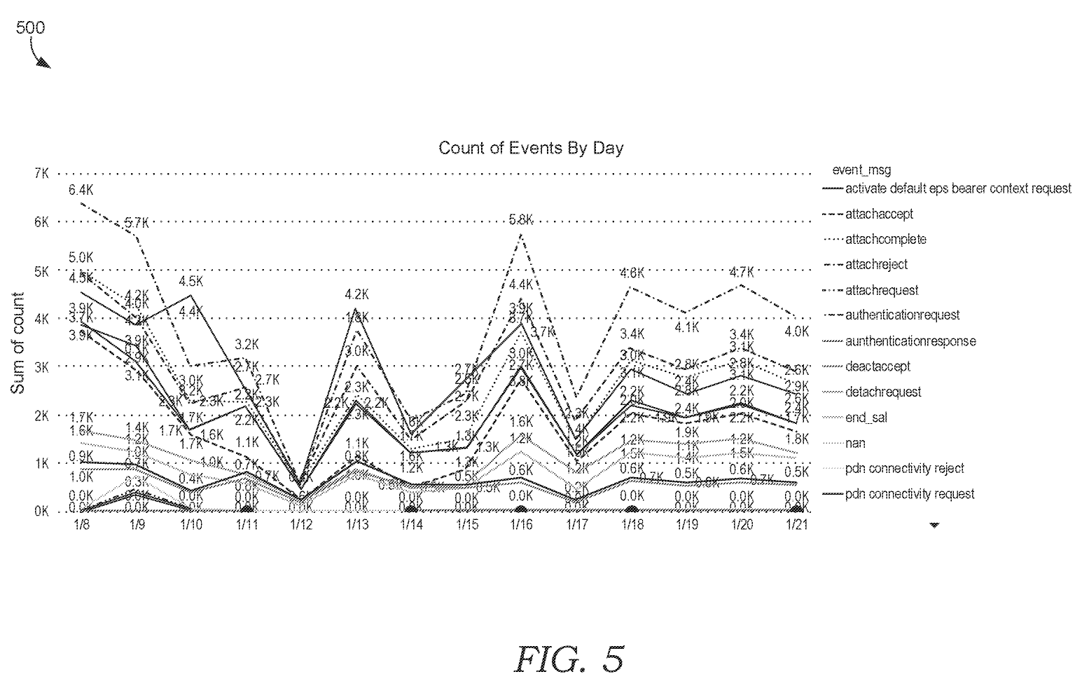

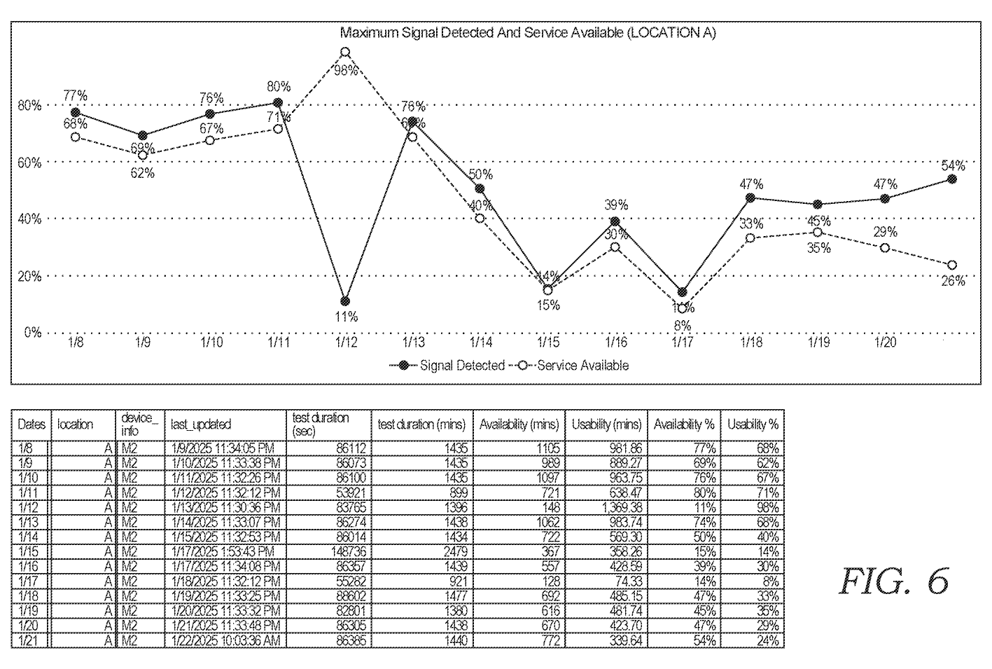

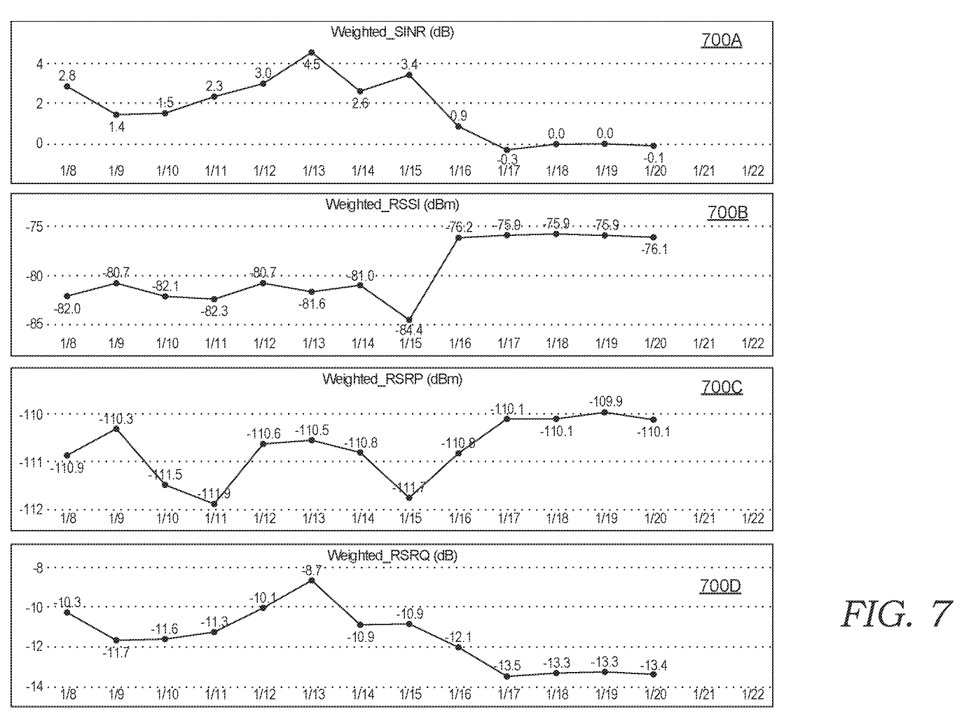

Graph 500 of FIG. 5 illustrates the continuous analysis of non-terrestrial network metrics for triggering the adjustment, associated with the non-terrestrial network, associated with the non-terrestrial network availability and the non-terrestrial network usability. For example, the non-terrestrial network availability and the non-terrestrial network usability may be determined based on the following non-terrestrial network data associated with M1-M6: event message, activated default request, attach accepted, attach completed, attach rejected, attach request, detach accepted, detach requested, etc. FIG. 6 illustrates a graph associated with maximum non-terrestrial network signal detected at a particular location, as well as a table illustrating the non-terrestrial network availability and usability determinations associated with this location. FIG. 7 illustrates graphs 700A, 700B, 700C, and 700D, which depict weighted Signal-to-interference-plus-noise ratio (SINR) associated with the non-terrestrial network metrics, weighted RSSI associated with the non-terrestrial network metrics, weighted Reference Signal Received Power (RSRP) associated with the non-terrestrial network metrics, and weighted Reference Signal Received Quality (RSRQ).

### Example Flowchart

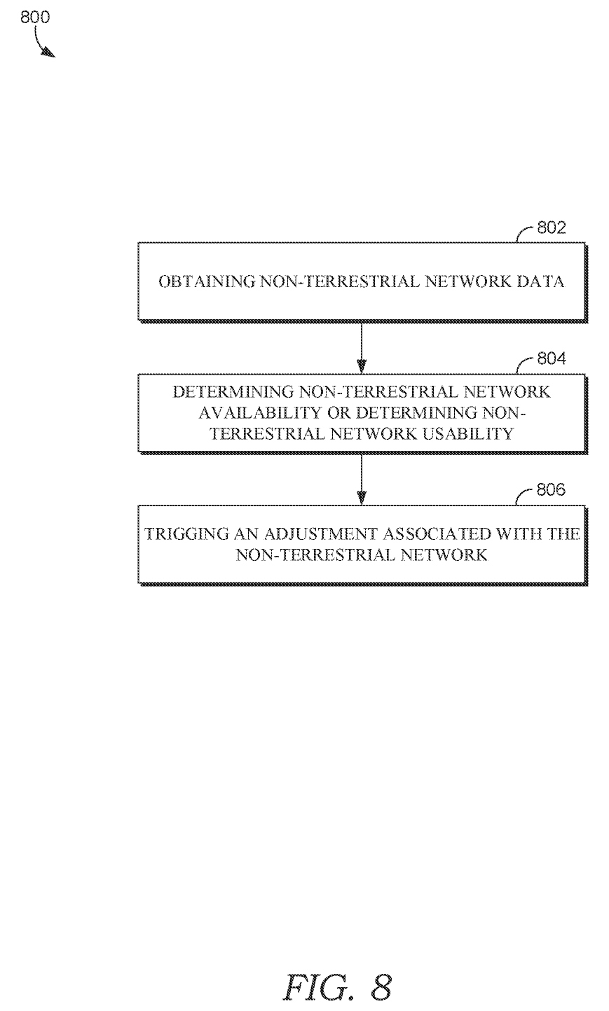

Having described the example embodiments discussed above, an example flowchart 800 is described below with respect to FIG. 8. Example flowchart 800 begins at step 802 with obtaining non-terrestrial network data. In embodiments, the non-terrestrial network data is obtained from one or more of the non-terrestrial network analysis system 104A and 104B from FIG. 1.

For example, the non-terrestrial network data may be obtained using one or more of: a computing device continuously sending itself a signal over the non-terrestrial network; a pair of computing devices including an origin device and terminator device, wherein the origin device transmits a signal over the non-terrestrial network to the terminator device that receives the signal from the origin device over a terrestrial network; a computing device that attaches and detaches to the non-terrestrial network; and a pair of computing devices including an origin device and terminator device, wherein the origin device transmits a signal over the terrestrial network to the terminator device that receives the signal over the non-terrestrial network.

In some embodiments, the non-terrestrial network data is obtained based on one or more of the computing device continuously sending itself the signal, the origin device transmitting the signal over the non-terrestrial network, the computing device attaching and detaching to the non-terrestrial network, and the terminator device that receives the signal over the non-terrestrial network being locked onto a frequency band associated with the non-terrestrial network to avoid connecting to the terrestrial network.

At step 804, a non-terrestrial network metric is determined using the non-terrestrial network data obtained. In some embodiments, the non-terrestrial network metric is non-terrestrial network availability. Additionally or alternatively, the non-terrestrial network metric is non-terrestrial network usability.

In some embodiments, the non-terrestrial network availability may be determined by identifying a duration that a particular non-terrestrial node beam of a particular non-terrestrial node served one or more of the: computing device continuously sending itself the signal, the origin device transmitting the signal over the non-terrestrial network, the computing device attaching and detaching to the non-terrestrial network, or the terminator device that receives the signal over the non-terrestrial network, or one or more combinations thereof. In some embodiments, the non-terrestrial network availability may be determined by causing the computing device, which is continuously sending itself the signal, to continuously ping a particular server. In some embodiments, the non-terrestrial network availability has a particular threshold for a particular communication service. For instance, if the non-terrestrial network availability is below that threshold, than the particular communication service may be paused for particular user device in a geographical area that is associated with the determined non-terrestrial network availability.

In some embodiments, the non-terrestrial network usability may be determined based on a connection trigger with the non-terrestrial network for one or more of the computing device continuously sending itself the signal, the origin device transmitting the signal over the non-terrestrial network, the computing device attaching and detaching to the non-terrestrial network, the terminator device that receives the signal over the non-terrestrial network, or one or more combinations thereof. The non-terrestrial network usability may be determined based on a signal fade, measured after the connection trigger and being associated with the connection trigger, that is below a threshold for one or more of the computing device continuously sending itself the signal, the origin device transmitting the signal over the non-terrestrial network, the computing device attaching and detaching to the non-terrestrial network, the terminator device that receives the signal over the non-terrestrial network, or one or more combinations thereof.

In some embodiments, the non-terrestrial network usability may be determined based on the non-terrestrial network that corresponds to radio resource control (RRC), enhanced service provider management (EPM), enterprise mobility management (EMM), etc., or one or more combinations thereof. In some embodiments, the non-terrestrial network usability may be determined using the following for one or more of the devices used to obtain the non-terrestrial network data (e.g., one or more of M1-M6 of FIG. 1): RACH RESULT = SUCCESS (AND) RRC STATE = CONNECTED (AND) EMM State = EMM_REGISTERED (AND) EMM Sub-state = EMM _REGISTERED_NORMAL SERVICE (+) RACH RESULT = SUCCESS (AND) RRC STATE = IDLE_CONNECTED (AND) EMM State = EMM_REGISTERED (AND) EMM Sub-state = EMM _REGISTERED_NORMAL SERVICE. In some embodiments, the non-terrestrial network usability may be determined using at least a portion of the non-terrestrial network data corresponding to a physical layer.

At step 806, an adjustment is triggered based on the non-terrestrial network metric. For example, the adjustment trigger may include an alarm that is provided to a particular terrestrial network node or the user devices associated with a geographical area that the non-terrestrial network metric corresponds to. For example, the alarm may cause one or more of the user devices to increase non-terrestrial node beam detection sensitivity, to transmit a signal at a higher power if one of the user devices is camping on the non-terrestrial node beam or to transmit a particular request, etc., or one or more combinations thereof. For example, one or more of these alarms may be triggered based on particular threshold levels for the non-terrestrial network availability and usability (e.g., bad availability and usability, bad usability but okay availability, etc.), etc. In some embodiments, the threshold are dynamic. In some embodiments, the thresholds may correspond to non-terrestrial network beam profiles generated using the non-terrestrial network data obtained by the system of FIGS. 1 or 2.

In some embodiments, triggering the adjustment may comprise providing a data service to a set of computing devices (e.g., UEs within a particular portion of a coverage area for a satellite) based on the non-terrestrial network usability being above a first threshold and the non-terrestrial network availability being above a second threshold. As another example, the triggering the adjustment may correspond to removing access to a data service from a set of computing devices based on the non-terrestrial network usability being below a first threshold and the non-terrestrial network availability being below a second threshold. In some embodiments, the adjustment may including toggling particular communication service(s) on and off for user devices as the non-terrestrial network usability and availability changes. In other embodiments, when the non-terrestrial network availability and usability both satisfy particular thresholds, the adjustment may include causing the user devices to toggle particular communication service(s) based on non-terrestrial network beam profiles generated using the system of FIG. 1. In some embodiments, based on the non-terrestrial network usability and availability, the adjustments associated with the non-terrestrial network may include causing a particular set of user devices to turn off voice over new radio or multimedia application features (e.g., to save battery) based on low usability and availability. In some embodiments, based on the non-terrestrial network usability and availability, the adjustments associated with the non-terrestrial network may include causing the non-terrestrial node to increase or decrease transmission power based on a particular transmission profile of the satellite network.

### Example Non-Terrestrial Node

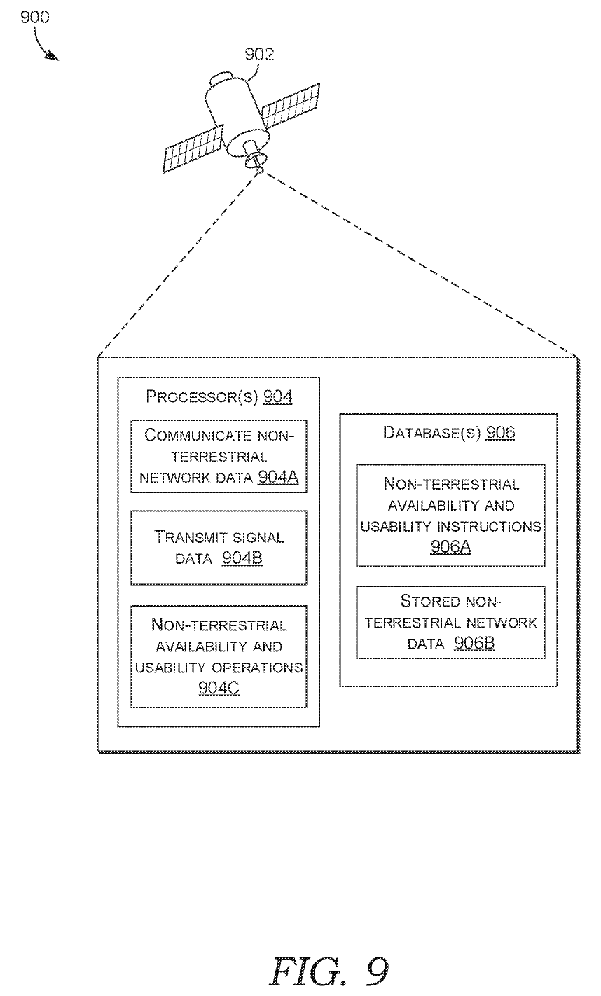

Referring now to FIG. 9, example diagram 900 is depicted of example non-terrestrial functionality suitable for use in implementations of the present disclosure. Example diagram 900 including example non-terrestrial node 902 is but one example of suitable anchor satellite functionality and is not intended to suggest any limitation as to the scope of use or functionality of the invention. Neither should example non-terrestrial node 902 be interpreted as having any dependency or requirement relating to any one or combination of components illustrated. In some embodiments, the non-terrestrial node 902 is the same as or similar to non-terrestrial node 102 of FIG. 1.

Example diagram 900 includes non-terrestrial node 902 having one or more processors 904 and one or more databases 906. Some functionality of the one or more processors 904 may include communicating non-terrestrial network data 904A (e.g., the data obtained from the particular system of FIG. 1), transmit signal data 904B (e.g., transmitting the signals from M1, M2, M4, and M6 of FIG. 1), and non-terrestrial availability and usability operations 904C (e.g., associated with the triggering of the adjustments or the adjustments themselves). The one or more databases 906 may include non-terrestrial availability and usability instructions 906A and stored non-terrestrial network data 906B.

In some embodiments, the non-terrestrial node 902 may be orbiting between about 300 kilometers (km) and 400km. As another example, the non-terrestrial node 902 may be a LEO satellite, a VLEO satellite, or another type of satellite. In some embodiments, the non-terrestrial node 902 is configured for direct-to-cell communications with user devices. In other embodiments, the non-terrestrial node 902 may be another type of non-terrestrial device, such as a balloon, a dirigible, an airplane, a drone (e.g., an unmanned aerial vehicle), a geosynchronous or geostationary earth orbit satellite, etc., or one or more combinations thereof.

In some embodiments, the one or more processors 904 may include a radiation-hardened processor, a field-programmable gate array, a system-on-chip processor, a radiation-tolerant microcontroller, a digital signal processor, an application-specific integrated circuit, a quad-core and multi-core processor, a PowerPC processor, another type of non-terrestrial processor, or one or more combinations thereof. In some embodiments, the one or more processors 904 may also have memory. In addition, in some embodiments, the one or more databases 906 may include radiation-hardened memory, flash memory, erasable programmable read-only memory, solid-state drives, ferroelectric radio access memory, magnetic random-access memory, onboard data storage systems, file systems, other types of non-terrestrial memory, or one or more combinations thereof.

The non-terrestrial availability and usability instructions 906A may be used by the one or more processors 904 to cause the one or more processors 904 to perform one or more non-terrestrial availability and usability operations 904C. In some embodiments, the non-terrestrial network data obtained using M1-M6 of FIG. 1 may be stored at the one or more databases 906. In embodiments, the one or more databases 906 may also store the non-terrestrial network metrics determined. In some embodiments, the non-terrestrial availability and usability operations 904C may include processing of the stored non-terrestrial network data 906B to generate the non-terrestrial network metrics. In some embodiments, non-terrestrial network beam profiles may be generated using the non-terrestrial network data 906B, and the non-terrestrial network beam profiles may be stored at the one or more databases 906. Historical triggers and adjustments may also be stored at the one or more databases 906. In embodiments, the non-terrestrial network data obtained and stored at the one or more databases 906 can be used in a feedback loop for enhancing the triggers and adjustments for the non-terrestrial network.

### Example Computing Device

Referring now to FIG. 10, a diagram is depicted of an example computing device suitable for use in implementations of the present disclosure. In particular, the example computer environment is shown and designated generally as computing device 1000. Computing device 1000 is but one example of a suitable computing environment and is not intended to suggest any limitation as to the scope of use or functionality of the invention. Neither should computing device 1000 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 10, computing device 1000 includes bus 1002 that directly or indirectly couples the following devices: memory 1004, one or more processors 1006, one or more presentation components 1008, input/output (I/O) ports 1010, I/O components 1012, power supply 1014 and radio(s) 1016. The memory 1004 may include non-terrestrial network availability and usability associated operating instructions 1004A, which may be executed by the processor(s) 1006 to perform non-terrestrial network availability and usability associated operations 1006A.

Although the components of FIG. 10 are shown with lines for the sake of clarity, in reality, delineating various components is not so clear, and metaphorically, the lines would more accurately be grey and fuzzy. For example, one may consider a presentation component, such as a display device to be one of I/O components 1012. As another example, processors, such as one or more processors 1006, have memory. The present disclosure hereof recognizes that such is the nature of the art, and reiterates that FIG. 10 is merely illustrative of an example computing environment for a user device that may be used in connection with one or more implementations of the present disclosure. Additionally, distinction is not made between such categories as “workstation,” “server,” “laptop,” “handheld device,” etc., as all are contemplated within the scope of FIG. 10 and refer to “computer” or “computing device.” In yet another example, bus 1002 may represent what may be one or more busses (such as an address bus, data bus, or combination thereof).

Computing device 1000 typically includes a variety of computer-readable media. Computer-readable media may be any available media that may be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 1004 includes computer-storage media in the form of volatile and/or nonvolatile memory. Memory 1004 may be removable, non-removable, or a combination thereof. Examples of memory 1004 may include solid-state memory, hard drives, optical-disc drives, etc., or one or more combinations thereof. The non-terrestrial network availability and usability associated operating instructions 1004A stored in memory 1004 may be used by the one or more processors 1006 to cause the one or more processors 1006 to perform non-terrestrial network availability and usability associated operations 1006A.

In some embodiments, the non-terrestrial network availability and usability associated operations 1006A may include continuously transmitting a signal (e.g., an SMS) over a non-terrestrial network, such as by pinging a particular server, so that the signal is delivered to the same device that sent it. In some embodiments, the non-terrestrial network availability and usability associated operations 1006A may include transmitting a signal over the non-terrestrial network to another computing device configured to receive the signal over a terrestrial network. In some embodiments, the non-terrestrial network availability and usability associated operations 1006A may include receiving a signal over the terrestrial network that was initially transmitted by another device over the non-terrestrial network. In some embodiments, the non-terrestrial network availability and usability associated operations 1006A may include attaching and detaching to the non-terrestrial network. In some embodiments, the non-terrestrial network availability and usability associated operations 1006A may include transmitting a signal over the terrestrial network to another computing device configured to receive the signal over the non-terrestrial network, or receiving a signal over the non-terrestrial network that was initially transmitted by another device over the terrestrial network. Non-terrestrial network data may be transmitted to storage for access associated with non-terrestrial network availability and usability determinations. In some embodiments, the non-terrestrial network availability and usability associated operations 1006A may include determining non-terrestrial network availability and usability or implementing an adjustment to a communication service based on the non-terrestrial network availability and usability.

Computing device 1000 also includes one or more processors 1006 that read data from various entities, such as bus 1002, memory 1004, or I/O components 1012. Examples of one or more processors 1006 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors or other suitable hardware configured to perform non-terrestrial network availability and usability associated operations 1006A using the non-terrestrial network availability and usability associated operating instructions 1004A, etc., or one or more combinations thereof.

One or more presentation components 1008 may present (e.g., to a person or other device) data indications (e.g., the non-terrestrial network availability and usability associated operating instructions 1004A). Examples of the one or more presentation components 1008 may include a display device, speaker, printing component, vibrating component, etc. Examples of the non-terrestrial network availability and usability associated interface(s) 1008A may include table 300 of FIG. 3, table 400 of FIG. 4, graph 500 of FIG. 5, the graph and table of FIG. 6, the graphs of FIG. 7, etc. Other examples of non-terrestrial network availability and usability associated interface(s) 1008A may include an alarm or notification that the non-terrestrial network availability and usability of a particular non-terrestrial node beam is unsatisfactory.

I/O ports 1010 may allow computing device 1000 to be logically coupled to I/O components 1012 or other devices. In some embodiments, only a portion of a plurality of I/O components 1012 may be built into computing device 1000. Illustrative I/O components 1012 may include a microphone, joystick, game pad, satellite dish, scanner, printer, wireless device, etc., or one or more combinations thereof. In some embodiments, the one or more presentation components 1008 may provide an indication (e.g., via the display or vibrating component) that the computing device 1000 is performing the non-terrestrial network availability and usability associated operations 1006A.

Radio 1016 may represent a radio that facilitates communication with a wireless telecommunications network. Illustrative wireless telecommunications technologies may include CDMA, GPRS, TDMA, GSM, and the like. Radio 1016 might additionally or alternatively facilitate other types of wireless communications including Wi-Fi, WiMAX, LTE, or other VoIP communications. As can be appreciated, in various embodiments, radio 1016 may be configured to support multiple technologies and/or multiple radios may be utilized to support multiple technologies. By way of example, the radio 1016 may be configured to support an 8-element MIMO antenna configuration for 5G smartphones or another number of elements for various antenna configurations for other generation smartphones or user devices for implementing non-terrestrial network availability and usability associated operations 1006A.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method comprising:
determining a non-terrestrial network metric of a non-terrestrial network from non-terrestrial network data obtained from:
a computing device continuously sending itself a signal over the non-terrestrial network;
a pair of computing devices including an origin device and terminator device, wherein the origin device transmits a signal over the non-terrestrial network to the terminator device that receives the signal from the origin device over a terrestrial network;
a computing device that attaches and detaches to the non-terrestrial network; and
a pair of computing devices including an origin device and terminator device, wherein the origin device transmits a signal over the terrestrial network to the terminator device that receives the signal over the non-terrestrial network; and
triggering an adjustment, associated with the non-terrestrial network, based on the non-terrestrial network metric determined.

2. The method according to claim 1, further comprising:
determining non-terrestrial network availability, being the non-terrestrial network metric, by identifying a duration that a particular non-terrestrial node beam of a particular non-terrestrial node served the computing device continuously sending itself the signal, the origin device transmitting the signal over the non-terrestrial network, the computing device attaching and detaching to the non-terrestrial network, and the terminator device that receives the signal over the non-terrestrial network; and
triggering the adjustment based on the non-terrestrial network availability.

3. The method according to claim 1, further comprising:
determining non-terrestrial network usability, being the non-terrestrial network metric, based on:
a connection trigger with the non-terrestrial network for each of the computing device continuously sending itself the signal, the origin device transmitting the signal over the non-terrestrial network, the computing device attaching and detaching to the non-terrestrial network, and the terminator device that receives the signal over the non-terrestrial network; and
a signal fade, measured after the connection trigger and being associated with the connection trigger, that is below a threshold for each of the computing device continuously sending itself the signal, the origin device transmitting the signal over the non-terrestrial network, the computing device attaching and detaching to the non-terrestrial network, and the terminator device that receives the signal over the non-terrestrial network; and
triggering the adjustment based on the non-terrestrial network usability.

4. The method according to claim 1, further comprising:
determining non-terrestrial network usability, being the non-terrestrial network metric, based on the non-terrestrial network that corresponds to radio resource control, enhanced service provider management, and enterprise mobility management; and
triggering the adjustment based on the non-terrestrial network usability.

5. The method according to claim 1, further comprising:
determining non-terrestrial network usability, being the non-terrestrial network metric, using the following for one or more of the devices from which the non-terrestrial network data was obtained: RACH RESULT = SUCCESS (AND) RRC STATE = CONNECTED (AND) EMM State = EMM_REGISTERED (AND) EMM Sub-state = EMM _REGISTERED_NORMAL SERVICE (+) RACH RESULT = SUCCESS (AND) RRC STATE = IDLE_CONNECTED (AND) EMM State = EMM_REGISTERED (AND) EMM Sub-state = EMM _REGISTERED_NORMAL SERVICE; and
triggering the adjustment based on the non-terrestrial network usability.

6. The method according to claim 1, wherein the non-terrestrial network data is obtained based on one or more of the computing device continuously sending itself the signal, the origin device transmitting the signal over the non-terrestrial network, the computing device attaching and detaching to the non-terrestrial network, and the terminator device that receives the signal over the non-terrestrial network being locked onto a frequency band associated with the non-terrestrial network to avoid connecting to the terrestrial network.

7. The method according to claim 1, further comprising:
determining the non-terrestrial network metric, being a non-terrestrial network availability, based on causing the computing device, which is continuously sending itself the signal, to continuously ping a particular server;
determining a second non-terrestrial network metric, being non-terrestrial network usability, using at least a portion of the non-terrestrial network data corresponding to a physical layer; and
triggering the adjustment based on the non-terrestrial network availability and the non-terrestrial network usability.

8. The method according to claim 7, the non-terrestrial network availability being determined based on a duration that a particular non-terrestrial node beam of a particular non-terrestrial node served the computing device continuously sending itself the signal.

9. The method according to claim 8, the non-terrestrial network usability being determined based on a connection trigger with the non-terrestrial network and a signal fade, measured after the connection trigger, that is below a threshold for one or more of the computing device continuously sending itself the signal, the origin device transmitting the signal over the non-terrestrial network, the computing device attaching and detaching to the non-terrestrial network, or the terminator device that receives the signal over the non-terrestrial network.

10. One or more computer storage media having computer-executable instructions embodied thereon, that when executed by at least one processor, cause the at least one processor to perform a method comprising:
determining a non-terrestrial network metric of a non-terrestrial network from non-terrestrial network data obtained from:
a computing device continuously sending itself a signal over the non-terrestrial network;
a pair of computing devices including an origin device that transmits a signal to a terminator device; and
a computing device that attaches and detaches to the non-terrestrial network; and
triggering an adjustment, associated with the non-terrestrial network, based on the non-terrestrial network metric determined.

11. The one or more computer storage media of claim 10, wherein the origin device transmits a signal over the non-terrestrial network to the terminator device that receives the signal from the origin device over a terrestrial network.

12. The one or more computer storage media of claim 11, the non-terrestrial network data being obtained from a second pair of computing devices including a second origin device and a second terminator device, wherein the second origin device transmits a signal over the terrestrial network to the second terminator device that receives the signal over the non-terrestrial network.

13. The one or more computer storage media of claim 11, further comprising:
determining non-terrestrial network usability, being the non-terrestrial network metric, using the following for one or more of the devices from which the non-terrestrial network data was obtained: RACH RESULT = SUCCESS (AND) RRC STATE = CONNECTED (AND) EMM State = EMM_REGISTERED (AND) EMM Sub-state = EMM _REGISTERED_NORMAL SERVICE (+) RACH RESULT = SUCCESS (AND) RRC STATE = IDLE_CONNECTED (AND) EMM State = EMM_REGISTERED (AND) EMM Sub-state = EMM _REGISTERED_NORMAL SERVICE; and
triggering the adjustment based on the non-terrestrial network usability.

14. The one or more computer storage media of claim 13, further comprising:
determining a second non-terrestrial network metric, being a non-terrestrial network availability, based on a duration that a particular non-terrestrial node beam of a particular non-terrestrial node served the computing device continuously sending itself the signal; and
triggering the adjustment based on the non-terrestrial network usability.

15. The one or more computer storage media of claim 14, further comprising:
determining that the non-terrestrial network usability is above a first threshold;
determining that the non-terrestrial network availability is above a second threshold; and
triggering the adjustment to provide a data service to a set of computing devices based on the non-terrestrial network usability being above the first threshold and the non-terrestrial network availability being above the second threshold.

16. The one or more computer storage media of claim 11, wherein the non-terrestrial network metric is a non-terrestrial network usability, the method further comprising:
determining a second non-terrestrial network metric, being a non-terrestrial network availability, based on the non-terrestrial network data;
determining that the non-terrestrial network usability is below a first threshold;
determining that the non-terrestrial network availability is below a second threshold; and
triggering the adjustment to remove access to a data service from a set of computing devices based on the non-terrestrial network usability being below the first threshold and the non-terrestrial network availability being below the second threshold.

17. A system comprising:
a first computing device configured to continuously send itself a signal over a non-terrestrial network;
a second computing device configured to transmit a signal over the non-terrestrial network to a third computing device, the third computing device configured to receive the signal from the second computing device from a terrestrial network; and
a fourth computing device configured to transmit a signal over the terrestrial network to a fifth computing device, the fifth computing device configured to receive the signal from the fourth computing device from the non-terrestrial network.

18. The system according to claim 17, the first computing device having a subscriber identification module (SIM), a system on chip (SoC) of the SIM being provisioned to avoid terrestrial attachment for the first computing device to be configured to send itself the signal over the non-terrestrial network.

19. The system according to claim 17, further comprising another computing device configured to attach and detach to the non-terrestrial network.

20. The system according to claim 19, further comprising a database that receives non-terrestrial network data from the first computing device, the second computing device, the third computing device, the fourth computing device, the fifth computing device, and the other computing device that attaches to and detaches from the non-terrestrial network.
